(19) United States
(12) Patent Application Publication
(10) Pub. No.: US 2014/0278576 A1
(43) Pub. Date: Sep. 18, 2014

(54) METHOD, APPARATUS, AND COMPUTER PROGRAM PRODUCT FOR OBTAINING COVERAGE REQUEST AUTHORIZATIONS

(71) Applicant: Invenger Technologies Inc., Simi Valley, CA (US)

(72) Inventors: Chandramohan Mariyal, Simi Valley, CA (US); Krishna Mohan Pai, Simi Valley, CA (US)

(73) Assignee: Invenger Technologies Inc., Simi Valley, CA (US)

(21) Appl. No.: 14/201,126

(22) Filed: Mar. 7, 2014

Related U.S. Application Data
(60) Provisional application No. 61/785,057, filed on Mar. 14, 2013.
(60) Provisional application No. 61/802,549, filed on Mar. 16, 2013.
(60) Provisional application No. 61/802,565, filed on Mar. 16, 2013.

(51) Int. Cl. G06Q 40/08

(52) U.S. Cl. CPC G06Q 40/08
USPC 705/4

(57) ABSTRACT

A method, apparatus, and computer program product are provided herein for obtaining multiple authorizations for a multiple payee coverage request and facilitating the distribution of coverage payments according to the request. An example method involves receiving a multiple payee coverage request to generate a coverage payment in accordance with a coverage plan, determining two or more payees based on the multiple payee coverage request, receiving transaction data from at least one of the two or more payees and associating the transaction data with the multiple payee coverage request, determining a distribution vehicle for each payee based, at least in part, on the transaction data received, and causing the coverage payment to be distributed according to the respective distribution vehicles determined.

### CROSS-REFERENCE TO RELATED APPLICATIONS

This application claims the benefit of U.S. Provisional Application No. 61/785,057 filed Mar. 14, 2013; U.S. Provisional Application No. 61/802,549 filed Mar. 16, 2013; and U.S. Provisional Application No. 61/802,565 filed Mar. 16, 2013, the content of each of which is incorporated herein in their entirety.

### FIELD OF THE INVENTION

Example embodiments of the present invention relate generally to insurance coverage plan management and, more particularly, to a method, apparatus, and computer program product for obtaining payment authorization for a coverage request from multiple payees.

### BACKGROUND

Consumers and businesses often purchase insurance to cover losses to personal or commercial property. Insurance may be purchased to cover a wide array of situations, such as to cover risk of financial liability or loss that a motor vehicle owner may face if his or her vehicle is involved in a collision resulting in property or physical damages (e.g., automotive insurance), damage to a physical structure and/or loss of items within a home (e.g., homeowner's or renter's insurance), etc.

When a loss occurs, the insurance company (the coverage provider) typically assesses the damage and estimates the loss. Conventional practice is for the coverage provider to cut a check to the insured for the loss amount. If the insurance policy is underwritten to include two or more individuals, such as husband and wife, then the live check is typically issued to both individuals. In cases where the damage is being fixed by a contractor, then the live check is typically issued to both the insured and the contractor as payees. The payees would have to agree as to who gets to deposit the check and then obtain endorsements on the check from the other payees.

Moreover, in situations involving financing of the damaged property (e.g., house or vehicle), the lender may also be involved in the process of paying out on the insurance claim. For example, in the case of automotive insurance, if the cost of repair and salvage exceeds the vehicle's market value, then the vehicle is declared a total loss. When the vehicle title is held by a financial institution that financed the vehicle, conventional practice is to cut a check to pay off the loan amount (paid to the financial institution) and, if any funds are left after paying off the loan, to cut a check for the remainder amount (paid to the vehicle owner). Paying off a loan may involve contacting the financial institution that issued the loan, obtaining the payoff amount, obtaining a letter of guarantee, cutting a check and mailing it to the financial institution, etc. In the context of a typical homeowner's insurance policy, where the purchase of the home was financed, the mortgagee or mortgage servicer may similarly be implicated.

Applicant has discovered problems with existing methods and systems for coverage plan management. Through applied effort, ingenuity, and innovation, Applicant has solved many of these identified problems by developing a solution that is embodied by the present invention and described in detail below.

### BRIEF SUMMARY

A method, apparatus, and computer program product are therefore provided for distributing a coverage payment authorized by multiple payees via an authorization system.

A method comprising receiving, via a processor, a multiple payee coverage request to generate a coverage payment in accordance with a coverage plan, determining, via the processor, two or more payees based on the multiple payee coverage request, receiving transaction data from at least one of the two or more payees and associating, via the processor, the transaction data with the multiple payee coverage request, determining, via the processor, a distribution vehicle for each payee based, at least in part, on the transaction data received, and causing, via the processor, the coverage payment to be distributed according to the respective distribution vehicles determined.

In some embodiments, the at least one of the two or more payees is a lender, the method further comprises generating coverage plan data describing an event triggering the multiple payee coverage request, and transmitting the coverage plan data, via the processor, to the lender.

In some embodiments, the two or more payees comprise at least one of a policyholder, a lender, or a vendor of goods or services.

In some embodiments, the coverage payment is divided into a first coverage payment and one or more subsequent coverage payments.

In some embodiments, receiving the multiple payee coverage request to generate a coverage payment in accordance with a coverage plan comprises receiving, from a coverage provider, the multiple payee coverage request, verifying a validity of the multiple payee coverage request, and transmitting a request for transaction data to at least one of the two or more payees.

In some embodiments, causing the coverage payment to be distributed comprises receiving, from each payee, an authorization, wherein the authorization comprises an electronic identifier, to distribute the coverage payment, and upon receiving the authorization from each payee, receiving, from a first account associated with a coverage provider, one or more funds and distributing the one or more funds according to the distribution vehicle determined by transferring the one or more funds to at least one second account associated with at least one of the two or more payees or providing at least one check to the at least one of the two or more payees.

In some embodiments, the one or more funds are transferred via an intermediary, the intermediary being at least one of a settlement funds transfer application, electronic billing application, or automated clearing house application.

In some embodiments, the method further comprises generating a notification describing a status of the multiple payee coverage request, and transmitting the notification to at least one of the two or more payees, wherein the notification comprises at least one of a text message, a link, an email message, an icon, or a button.

An apparatus comprising at least one processor and at least one memory including computer program code, the at least one memory and the computer program code configured to, with the processor, cause the apparatus to at least receive a multiple payee coverage request to generate a coverage payment in accordance with a coverage plan, determine two or more payees based on the multiple payee coverage request, receive transaction data from at least one of the two or more payees and associate the transaction data with the multiple payee coverage request, determine a distribution vehicle for each payee based, at least in part, on the transaction data received, and cause the coverage payment to be distributed according to the respective distribution vehicles determined.

A computer program product comprising at least one non-transitory computer-readable storage medium having computer-executable program code portions stored therein, the computer-executable program code portions comprising program code instructions for receiving a multiple payee coverage request to generate a coverage payment in accordance with a coverage plan, determining two or more payees based on the multiple payee coverage request, receiving transaction data from at least one of the two or more payees and associating the transaction data with the multiple payee coverage request, determining a distribution vehicle for each payee based, at least in part, on the transaction data received, and causing the coverage payment to be distributed according to the respective distribution vehicles determined.

Additional features and advantages of the present invention will be set forth in portion in the description which follows, and in portion will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

The above summary is provided merely for purposes of summarizing some example embodiments to provide a basic understanding of some aspects of the invention. Accordingly, it will be appreciated that the above-described embodiments are merely examples and should not be construed to narrow the scope of the invention in any way. It will be appreciated that the scope of the invention encompasses many potential embodiments in addition to those here summarized, some of which will be further described below.

### BRIEF DESCRIPTION OF THE DRAWINGS

Having therefore described certain example embodiments of the present disclosure in general terms, reference will now be made to the accompanying drawings, which are not necessarily drawn to scale, and wherein:

FIG. 1 illustrates a schematic block diagram of a network environment including an authorization system in accordance with an example embodiment of the present invention;

FIG. 2 is a flowchart showing an exemplary process for authorizing the distribution of funds by a payee in accordance with an example embodiment of the present invention;

FIG. 3 is a flowchart showing an exemplary process for an authorization system in accordance with an example embodiment of the present invention;

FIG. 4 is a flowchart showing an exemplary process of receiving multiple payee coverage requests in accordance with an example embodiment of the present invention;

FIG. 5 is a flowchart showing an exemplary process of distributing a coverage payment in accordance with an example embodiment of the present invention;

FIG. 6 is a block diagram of an authorization system in accordance with an example embodiment of the present invention;

FIG. 7 illustrates a process for authorizing the distribution of a coverage payment in a multiple party scenario;

FIG. 8 illustrates a process for authorizing the distribution of a coverage payment in a multiple party scenario involving a mortgagee; and

FIG. 9 illustrates a process for authorizing the distribution of a coverage payment in a multiple party scenario involving a lender in a total vehicle loss situation.

### DETAILED DESCRIPTION OF VARIOUS EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein. Rather, these embodiments are provided so that this disclosure will satisfy applicable legal requirements. Like numbers refer to like elements throughout.

A coverage plan may be purchased by a consumer to cover losses to personal property. The term “coverage plan” and similar terms may be used interchangeably to refer to the scope of protection provided under a warranty, service contract, insurance policy, and/or the like. The coverage plan may list perils insured against, properties covered, locations covered, individuals insured, and/or limits of indemnification.

As noted above, a coverage plan may be an automotive insurance product placed on a vehicle (e.g., a personal, commercial, or recreational vehicle) that covers the risk of financial liability or loss a motor vehicle owner may face if the vehicle is involved in a collision resulting in property and/or physical damages. As another example, a coverage plan may be an insurance product placed on property (e.g., house, apartment, condo, mobile home, etc.), and/or other like products. A homeowner's coverage plan may cover damage to the physical structure of the house or apartment, damage to or loss of items within the structure (e.g., furniture, clothing, electronics, appliances, artwork, jewelry, etc.), and/or the like. Similarly, renter's insurance may cover damage to or loss of many of the same items, excluding fixtures and the like. Although the examples provided herein describe embodiments of the present invention in the context of automotive and/or homeowner's or renter's insurance, it is understood that various other types of insurance products may benefit from embodiments of the present invention.

When a loss covered by the coverage plan occurs, a provider of the coverage plan will typically assess the damage and estimate the loss. The term “coverage provider” refers to the issuer of an insurance product or any company or agency that receives payment of a premium and, in return, provides a guarantee of compensation for specified loss or damage. In some embodiments, a coverage provider may include any company or agency that makes funds available to another with the expectation that the funds will be repaid, plus any interest and/or fees.

According to conventional practice, a coverage provider generally issues a check for the coverage payment once the claim under the coverage plan has been approved. The term “coverage payment” refers to an amount of money that is paid to one or more payees by the coverage provider under the terms of the coverage plan for the particular claim. The term “payee” refers to any person, company, or agency to which funds are to be paid. For example, for coverage plans that are underwritten to include two or more payees, such as a husband and wife, a single check is issued to both payees. Depending on the particular scenario, however, a payee may include the person or persons whose property is covered under the coverage plan, a financial institution, finance company, leasing company, lender, policyholder, mortgagee, mortgagor, mechanic, repairman, technician, contractor, lien holder, property owner, vendor, and/or the like. For example, when property damage is being repaired by a contractor, a check may be issued by the provider to two payees—the policyholder and the contractor. In addition to the costs incurred by a coverage provider associated with cutting and mailing a check, listing multiple payees on a check often presents challenges to the payees in that the payees must first come to an agreement about who will deposit the check (e.g., into which account) and then obtain endorsements on the check from each payee. Moreover, alternative methods of disbursing the coverage payment, such as by using a prepaid card or debit card, by electronic direct deposit, etc., which may be preferred by the payees, are typically unavailable in a multiple payee situation.

In the event of a total loss on a bank-owned (e.g., financed) insured vehicle, where the cost of repair and salvage of the vehicle exceeds its market value, conventional practice is to issue a first check to the finance company to pay off the loan and then issue a second check to the vehicle owner, if any funds remain after paying off the loan. Paying off a loan may involve many steps, including contacting the finance company that issued the loan, obtaining the payoff amount, obtaining a letter of guarantee, issuing a check, and mailing the check to the financial institution. Furthermore, while vehicle owners often have the ability to electronically pay loan installments to the financial institution that issued the loan, providers of coverage plans are generally unable to electronically pay off loans or make electronic payments to these financial institutions.

In a mortgage scenario, when a homeowner suffers losses against a homeowner's coverage plan, such as structural damage to the house, loss of or damage to the contents of the home, impairment of the use of the home, loss of personal possessions, and/or incurred liability for accidents that may happen on the homeowner's property, conventional practice is to issue a check for the loss amount covered by the coverage plan. If the homeowner financed the purchase of the property by taking out a mortgage, then the coverage provider typically sends the homeowner a single check issued to multiple payees—the mortgagee (e.g., the lender) and the homeowner(s). The homeowner may then take the check to the mortgagee. The mortgagee then typically obtains the claim documents from the coverage provider and initiates an internal claim investigation to determine whether the homeowner should receive some or all of the claim funds. The above mentioned processes require time, result in expensive check printing and distribution costs, limit the payee's distribution options, and are susceptible to fraud and loss of the check.

Accordingly, the methods, apparatus, and computer program products described herein provide mechanisms for managing and/or otherwise ascertaining multiple authorizations for a multiple payee coverage request to facilitate the distribution of claim funds to payees. An authorization system including a request module, a distribution module, and a notification module as described herein, is provided according to some embodiments and may be configured to receive multiple payee coverage requests, via the request module, to generate a coverage payment in accordance with a coverage plan. As used herein, the term “multiple payee coverage request” refers to a request for a coverage payment to be made to at least two payees based on the terms of a coverage plan.

### Overview

With reference to FIG. 1, a network environment is illustrated according to some embodiments, in which an authorization system 110 is provided that is configured to communicate with a coverage provider 190, two or more payees 180, and, in some cases, an intermediary 170, via a network 40, such as the Internet, as described in greater detail below. A multiple payee coverage request may be received by the authorization system 110 from a source, such as the coverage provider 190. For example, the coverage provider may be an Auto Insurance Carrier that is associated with an auto coverage plan. As another example, the coverage provider may be a Homeowner's Insurance Carrier that is associated with a homeowner's coverage plan.

In some embodiments, the coverage provider 190 may access the authorization system 110 via a computer, server, or other user device that is capable of establishing a connection to the network 40. In some cases, for example, a service provider portal or other web-based user interface may be accessed by the coverage provider 190 via the network 40, where the service provider portal is configured to allow the coverage provider to provide information to the authorization system 110 regarding one or more multiple payee coverage requests, as described in greater detail below. The authorization system 110 may, in some embodiments, include one or more servers that are maintained by a service provider for the purpose of facilitating the collection of information, the processing of multiple payee coverage requests, and/or the disbursement of coverage payments according to the relevant coverage plans. Accordingly, in some cases, the authorization system 110 may be accessible via the service provider portal to only certain coverage providers who have, for example, signed up or subscribed to the services provided by the service provider. Upon subscribing to such services, for example, the coverage provider 190 may receive log-in and password information that allow the coverage provider 190 to access the service provider portal over a secure line so as to enable the transmission of multiple payee coverage requests to the authorization system 110, among other benefits and services provided via the authorization system as described below.

For example, the authorization system 110 may be configured to verify the validity of the multiple payee coverage request received from the coverage provider 190, such as by accessing data regarding the associated coverage plan and/or individuals associated with the coverage plan or multiple payee coverage request and comparing this data with the information in the multiple payee coverage request. Further, the authorization system 110 may be configured to request transaction data from one or more of the payees, e.g., by transmitting an email to each payee, as described below.

In this regard, in some embodiments, the authorization system 110 may be configured to determine at least two payees based on the multiple payee coverage request that is received from the coverage provider 190. For example, in the event of the total loss of a vehicle, in which the vehicle was financed by a husband and wife to a finance company, the authorization system may determine that the payees are the bank through which the vehicle was finance, the husband, and the wife.

The term “transaction data” refers to data that is associated with the action or process of debiting and/or crediting an account to pay a person, company, or agency. Transaction data may include data associated with an amount paid or payable. Transaction data may be defined by coverage data (e.g., information describing the coverage plan under which the multiple payee coverage request is made, such as an insurance policy number, name of insured, etc.), account data (e.g., information regarding an account into which the payee wishes to have the coverage payment distributed), identity data (e.g., the name and address of the account holder), and/or the like. For example, transaction data may include account holder name “Ted Jones,” account number “1000,” and routing number “200000000” for Ted's personal checking account at Ted's bank.

In some embodiments, the authorization system 110 may be further configured to determine a distribution vehicle for each payee, based at least in part, on the transaction data received. The term “distribution vehicle” refers to a chosen way of crediting funds, debiting funds, receiving funds, and/or the like, such as for distributing the coverage payment to the payees. For example, the distribution vehicle may include a debit card, automated clearing house disbursement, direct deposit, prepaid card, direct debit, electronic funds transfer, one or more checks, and/or the like and combinations of the same. For example, in the event of a total loss vehicle, funds from a coverage provider's reserve account (e.g., a settlement account) may be paid to a finance company that financed the purchase of a vehicle by a husband and wife. In this case, the authorization system 110 may determine that the appropriate distribution vehicle with respect to funds to be paid to the finance company (e.g., the portion of the coverage payment that satisfies the vehicle loan) is direct deposit into the finance company's account; the distribution vehicle with respect to funds to be paid to the husband co-owner of the vehicle (e.g., the remainder of the coverage payment after the vehicle loan is paid off) is direct deposit into his personal checking account; and the distribution vehicle with respect to funds to be paid to the wife co-owner of the vehicle (e.g., the remainder of the coverage payment after the vehicle loan is paid off) is a prepaid debit card. A determination of the appropriate distribution vehicle may be made, for example, based on information received from the payees regarding their preferences, based on the transaction data, or based on predefined policy or procedures with respect to the particular payee, as described in greater detail below.

As shown in FIG. 1, in some cases the authorization system 110 may be configured to communication via the network 40 with an intermediary to determine or gain access to one or more of the distribution vehicles for a particular payee. For example, in the case of a financial institution providing the financing for a vehicle, the account designated by the financial institution for receiving funds to settle a loan from a coverage provider in the event of a total loss of the financed vehicle may be a special account that is not identifiable or accessible to banks or other financial institutions (e.g., a bank associated with the coverage provider). In this case, the coverage provider may only be able to make a coverage payment to the financial institution financing the vehicle through check and may be unable to make the coverage payment through other means, such as via electronic funds transfer. A third party company, agency, etc., however, may be granted special privileges by the financial institution financing the loan, such that this third party may be able to provide information regarding the special account to approved entities (such as the coverage provider) for the purpose of facilitating distribution of the coverage payment to the financial institution for settling the loan.

Accordingly, the term “intermediary” refers to a program or software that provides access to data associated with a payee, coverage provider, entity, and/or the like, such as access to an account associated with a loan financer as described above. An intermediary may include, for example, an electronic billing system, automated clearing house system, electronic bill payment and presentment system, Check 21 system, electronic funds transfer system, and/or any other settlement funds transfer system and/or derivative applications.

Moreover, as used herein, the term “account” refers to an arrangement in which a bank, company, entity, person, and/or the like keeps a record of funds. In some embodiments, an account may be associated with a coverage provider, payee, or other entity and may vary based on type (e.g., checking, savings, business, money market, deposit, settlement, escrow, retirement, reserves, trust, and/or the like).

### The Authorization System

Using the concepts introduced above, and described in further detail herein, the authorization system 110 shown in FIG. 1 may be configured to determine one or more authorizations of coverage requests, and, as a result, distribute the appropriate coverage payment to at least two payees based on the distribution vehicle designated by each payee and/or determined by the authorization system.

Turning now to FIG. 2, an example block diagram of an authorization system 110 is shown for authorizing a multiple payee coverage request is illustrated. The authorization system 110 may include various modules or selections of independent electronic circuits packaged onto a circuit board to provide a basic function of the authorization system. For example, in some embodiments, the authorization system 110 may include a request module 120, a distribution module 125, and a notification module 130. Each of the modules 120, 125, 130 may comprise or have access to a processor (e.g., processor 550 shown in FIG. 6) and a memory. For example, one or more of the modules 120, 125, 130 may include or have access to one or more databases, such as a coverage provider database 140, a merge database 150, and a payee database 160, as illustrated. In general, the process may receive multiple payee coverage requests, via the request module 120, stored in a database (e.g., coverage provider database 140) to generate a coverage payment in accordance with a coverage plan. The modules 120, 125, 130 may, in some cases, be configured to communicate with each other, such as to exchange information, and one or more of the modules may further be configured to communicate with entities outside the authorization system 110, including devices and systems associated with the coverage provider 190, one or more of the payees 180, and other applications 170, as described in greater detail below.

In some embodiments, the request module 120 is configured to receive one or more multiple payee coverage requests from a coverage provider and to determine the appropriate payees for receiving a coverage payment under the request. The distribution module 125 may be configured to determine an appropriate distribution vehicle for the coverage payment for each payee, and the notification module 130 may be configured to provide notifications to one or more of the payees and/or coverage provider regarding a particular multiple payee coverage request, as described below.

As described above with reference to FIG. 1, a coverage provider 190 may transmit a multiple payee coverage request to the authorization system 110 (e.g., via a service provider portal or other user interface) upon receiving a claim under a coverage plan from a claimant. For example, an on-line form may be presented to the coverage provider 190 via the service provider portal or other user interface, and upon receiving data identifying a claim at issue, such as a claim number, the on-line form may be at least partially pre-populated with data accessed from the coverage provider's systems and/or databases relating to the identified claim. This may include information regarding the approved claim, coverage payment amount, payees, etc. that is stored in the coverage provider's systems (e.g., in the coverage provider database 140). The completed on-line form in such a scenario may constitute the multiple payee coverage request.

The multiple payee coverage request may identify a coverage payment in accordance with the coverage plan (e.g., as previously determined by the coverage provider 190) that is to be distributed to at least two payees. The multiple payment coverage request may designate at least two payees, an amount of the coverage payment, a coverage identifier, and/or the like. The term “coverage identifier” may be used to refer to an identifier associated with the particular property covered by the coverage plan under which the multiple payee coverage request is made for identification, reference, record-keeping, association, and other like purposes. A coverage identifier may include, for example, a vehicle identification number, serial number, account number, global positioning system (GPS) location, assessor's identification number, assessor's parcel number, property identification number, property account number, tax account number, Sidwell number, longitude and latitude description, and/or the like.

In one example, a multiple payee coverage request may include three payees, such as a husband and wife “Tom and Tonya Fox” and mortgagee “Home Bank,” for a coverage payment in the amount of $10,000 covered under a coverage plan, for example, a homeowner's coverage plan with coverage identifier 1111-XXX.

Request module 120 may be configured to receive the multiple payee coverage request from a source, such as a coverage provider 190 as described above. For example, a coverage provider 190 associated with the homeowner's coverage plan may be carrier “Home Insurer.” The request module 120 may receive a multiple payee coverage request entered via a service provider portal or similar user interface by Josh Smith, a Home Insurer employee, as described above. In some embodiments, request module 120 may be configured to verify the multiple payee coverage request received from the coverage provider. For example, the request module 120 may access the coverage provider database 140 and/or payee database 160 and may compare the information provided in the multiple payee coverage request against the data stored in the databases 140, 160 to verify the accuracy and/or authenticity of the information.

In some example embodiments, request module 120 may transmit a request for transaction data to at least one of the two payees. In the example above, request module 120 may transmit a request for transaction data to each payee (Tom, Tonya, and Home Bank) requesting transaction data for the multiple payee coverage request, such as the preferred method of receiving the coverage payment, amount of the payment desired (e.g., when the coverage payment is to be shared between two payees, such as husband and wife), account numbers for routing the coverage payment, address information, etc. In some example embodiments, the transaction data received, via request module 120, from a payee and associated with a multiple payee coverage request may be stored in another database, such as a merge database 150, memory 515 (shown in FIG. 6), and/or the like.

Request module 120 may be configured to determine, via a processor (e.g., processor 550 of FIG. 6), two payees based on the multiple payee coverage request. For example, in the event of a flood at the Fox home, funds from Home Insurer's reserve account may be paid to policy holders Tom and Tonya Fox. The multiple payee coverage request received by authorization system 110, via request module 120, may indicate that the payees who may authorize the distribution of the coverage payment are mortgagee Home Bank (which financed the purchase of the house and to which the homeowners owe a monthly mortgage payment), Tom Fox, and Tonya Fox.

In some example embodiments, authorization system 110 (e.g., through the request module 120 and/or processor 550) may be configured to receive transaction data from at least one of the two payees and to associate the transaction data with the multiple payee coverage request. As described above, the transaction data may be defined by coverage data, account data, identity data, and/or the like. For example, the request module 120 (e.g., in conjunction with the notification module 130) may transmit an email to Tonya Fox requesting transaction data for the multiple payee coverage request awaiting her authorization. The request module 120 may then receive transaction data from Tonya that includes the account holder name “Tonya Fox,” account number “8888” and routing number “999999999” for Tonya's personal checking account at Tonya's bank.

In addition, the authorization system 110 may be configured to receive an authorization from each payee. The authorization may comprise an electronic identifier that authorizes the distribution of the coverage payment. The term “electronic identifier” refers to an identifier that indicates that a person, company, agency, vendor, and/or the like adopts the intentions recorded in a particular document, intends to execute an agreement, intends to sign a record, authorizes the happening of an event, and/or the like. In this regard, the electronic identifier is similar to a hand-written signature that a payee might provide on a check prior to depositing the check into his or her bank account in conventional systems. An electronic identifier may include an electronic sound, signature, symbol, process, personal identification number, biometric identifier, and/or the like. In some embodiments, the authorization (e.g., the electronic identifier) may be included in the transaction data received from the payee by the request module 120. In other embodiments, a separate communication may be made to the payee requesting authorization for the distribution of the coverage payment, such as by the distribution module 125 (e.g., in conjunction with the notification module 130). The receipt of the authorization may trigger the distribution of the coverage payment in accordance with the determined distribution vehicle, as described below.

In some embodiments, distribution module 125 may determine a distribution vehicle for each payee, based at least in part, on the transaction data received. A distribution vehicle may include a debit card, automated clearing house disbursement, direct deposit, prepaid card, direct debit, electronic funds transfer, checks, and/or the like. For example, upon receiving the transaction data and/or authorization from each payee, the distribution module 125 may request and receive funds from an account associated with the coverage provider (e.g., a first account). The distribution module 125 may distribute the funds according to the distribution vehicle determined by transferring the funds to at least one second account associated with at least one of the two payees or providing at least one check to at least one of the two payees.

In some embodiments, the coverage payment may be divided between at least two payees. For example, the portion of a coverage payment to be received by vehicle co-owners Ted and Jessica Jones under an automotive coverage plan may be further divided and distributed according to each of their selected distribution vehicles (e.g., where the selection by the payees was included in the transaction data). For example, distribution module 125 may determine (e.g., based on the transaction data received by the request module 120) that Ted selected distribution vehicle “direct deposit,” while Jessica selected “check.” In other embodiments, the coverage payment may be divided into a first coverage payment and one or more subsequent coverage payments. For example, In the event of damage to real property, the mortgagee may place the coverage payment into an escrow account and may authorize a first coverage payment to be made to initiate the home repair and one or more subsequent coverage payments to be made as the home repair is completed.

In another example in which Ted Jones and Jessica Jones financed their vehicle through America Bank and the vehicle is not yet paid off, in the event of a total loss of the vehicle, the distribution module 125 may transfer the settlement amount that satisfies the vehicle loan to the finance account designated by America Bank. The distribution module 125 may then transfer a portion of the coverage payment (e.g., a portion of the remainder of the coverage payment after the loan is paid off) to co-owner Ted Jones into his personal checking account according to his indicated preference, and the amount to be distributed to Jessica Jones may be transferred to a prepaid debit card according to her designated preference.

With continued reference to FIG. 2, in some example embodiments, authorization system 110 may be configured to access an intermediary, such as via application 170. In some embodiments, the request module 120 may be configured to access the intermediary application 170 to verify transaction data. For example, an intermediary may verify the transaction data received from a payee by verifying that the account number entered by the payee is associated with an account holder by the same name and that the account number is a valid account at the payee's bank.

In other example embodiments, at least one of the two payees may be a lender, such as a financer of a car loan or home mortgage. In cases in which the lender is not able to provide account information for distribution of the coverage payment to the lender according to the lender's protocols or normal operating procedures, such information may be available through an intermediary, as described above. Accordingly, the distribution module 125 may receive information relating to the distribution vehicle for the coverage payment to be made to the lender via the intermediary (e.g., via communication with the application 170 associated with the intermediary, such as a server, database, or other device associated with the intermediary). Such information may be incorporated into transaction data received directly from the lender, may supplement the transaction data, or may be the transaction data, such as in a case where the intermediary provides other or all information forming the transaction data. The account or other data received via the application 170 may include an account number or routing information associated with the lender in response to a request from the authorization system 110 (e.g., from the distribution module 125), for access to the account associated with the lender, such that the coverage payment can be distributed to the lender via the account.

In example embodiments in which at least one of the two payees is a lender, authorization system 110 may be configured to generate coverage plan data describing the event triggering the multiple payee coverage request. As described above, the event may be the total loss of a vehicle, loss of or damage to personal property, loss of or damage to real property, and/or the like. Further, authorization system 110 may generate and transmit the coverage plan data (e.g., via the request module 120, the distribution module 125, and/or the processor 550 of FIG. 6) to the lender. The coverage plan data may be used by the lender to fulfill the lender's own processes in determining whether a valid claim under the coverage plan has been made. In this regard, the coverage plan data may include excerpts from or a summary of the multiple payee coverage request received from the coverage provider, such that information describing the event triggering the multiple payee coverage request, the coverage plan, and/or the coverage payment and parties involved can be investigated and independently verified by the lender according to the lender's own procedures without requiring the homeowner or vehicle owner to manually describe the events to the lender in an effort to get his or her portion of the coverage payment. Rather, information that has already been documented and recorded is automatically transmitted to the lender via the coverage data, as described above.

In some embodiments, distribution module 125 may distribute a coverage payment that is to be divided between at least two payees. In other embodiments, the coverage payment may be divided into a first coverage payment and one or more subsequent coverage payments. For example, in the event of damage to real property, the distribution module 125 may cause funds to be transferred from the coverage provider's reserve account into the mortgagee's escrow account. Distribution module 125 may transfer an initial portion of the coverage payment from the escrow account to a husband and wife's joint checking account to cover a home repair down payment. Distribution module 125 may then transfer one or more subsequent portions of the coverage payment from the bank's escrow account to the joint owners' joint checking account as the home repairs are completed.

In another example embodiment, authorization system 110 may be configured to generate a notification, via notification module 130. In general, a notification may be generated and transmitted to a payee to communicate about the multiple payee coverage request. For example, the notification may describe a status of the multiple payee coverage request. In some embodiments, notification module 130 may transmit the notification to at least one of the two payees. The notification may include a text message, link, email message, icon, button, and/or the like. For example, notification module 130 may generate a notification when a first payee authorizes a coverage payment. Notification module 130 may transmit the notification, via an email to the payee, to confirm the authorization.

For example, in cases in which multiple authorization events for a coverage payment are required for the distribution of coverage payment funds, a first party may provide authorization either by logging on to an authorization website or using a smart phone. In some cases, the authorization may be confirmed by enabling Knowledge Based Authentication (KBA) questions. A message may then be sent to the person who first authorized the coverage payment confirming her activation event. Messages may also be sent to the additional payees requesting authorization. In some cases, the messages may be sent asynchronously. For example, each message may be sent independently of the others, and the order in which the messages are sent and acted upon may be irrelevant. If the last payee has not provided electronic authorization, the process may repeat, and a new message may be sent to the next payee. If all the necessary payees have authorized the payment, the authorization system 110 (e.g., via the distribution module 125) may automatically issue prepaid card(s) or deposit funds to the respective accounts provided by the payees, as described above.

### Ascertaining Multiple Authorizations for a Multiple Payee Coverage Request

Having now provided the above example embodiments, FIGS. 3, 4, and 5 describe in further detail the systems and corresponding components configured to provide the multiple payee coverage request authorization and coverage payment distribution methods as described herein. FIG. 3 shows an example method that may be executed by one or more machines (some examples of which are discussed in connection with FIGS. 2 and/or 6) to receive a multiple payee coverage request in some embodiments as discussed herein. As shown in block 210, an apparatus such as authorization system 110, may include means, such as request module 120 and processor 550 or the like, for receiving multiple payee coverage requests to generate a coverage payment in accordance with a coverage plan. For example, a multiple payee coverage request may be received when a coverage provider enters the multiple payee coverage request into an authorization system, such as authorization system 110. The coverage provider may enter a multiple payee coverage request that includes a coverage payment to cover the loss of property, damage to property, and/or the like.

As shown in block 220 of FIG. 3, the authorization system 110, may include means, such as request module 120, processor 550, coverage provider database 140, merge database 150, payee database 160 or the like for determining two payees based on a multiple payee coverage request. For example, the authorization system 110, via request module 120, may access coverage provider database 140, merge database 150, and/or payee database 160 to determine the payees who may authorize the distribution of the coverage payment for the particular multiple payee coverage request.

As shown in block 230 of FIG. 3, authorization system 110 may include means, such as request module 120, processor 550, payee database 160, or the like, for receiving transaction data from at least one of the two payees. The transaction data may then be associated with the multiple payee coverage request. Transaction data may be defined by coverage data, account data, identity data, and/or the like. For example, authorization system 110 may transmit a text message to the payee's mobile device (e.g., where the phone number is stored in payee database 160 and/or memory 515) to request transaction data for the multiple payee coverage request awaiting the payee's authorization. The request module 120 may receive transaction data from the payee that includes account data such as the account holder name, account number, and routing number. The request module may also receive transaction data in the form of identity data to distribute a check.

As shown in block 240 of FIG. 3, authorization system 110 may include means, such as distribution module 125 and processor 550 or the like, for determining a distribution vehicle for each payee based, at least in part, on the transaction data received as shown in block 240. A distribution vehicle may include a direct deposit, prepaid card, direct debit, electronic funds transfer, check, and/or the like. For example, distribution module 125 may access merge database 150 to determine the distribution vehicle each payee selected.

As shown in block 250 of FIG. 3, the authorization system 110, may include means, such as request module 120, processor 550, payee database 160, or the like to cause the coverage payment to be distributed according to the respective distribution vehicles determined and the authorization provided by each payee. For example, upon verifying that each payee has authorized the coverage payment distribution, distribution module 125 may receive funds from a reserve account held by a coverage provider and may further transmit such funds to the payee's account.

### Receiving Coverage Requests

FIG. 4 shows an example method that may be executed by one or more machines (some examples of which are discussed in connection with FIGS. 2 and/or 6) to receive a multiple payee coverage request to generate a coverage payment in accordance with a coverage plan in some embodiments as discussed herein. As shown in block 310, an apparatus such as authorization system 110 may include means, such as request module 120 and processor 550 or the like, for receiving multiple payee coverage requests. In some embodiments, authorization system 110 may further include means, such as request module 120 and processor 550 or the like, for verifying a validity of the multiple payee coverage request. In other embodiments, authorization system 110 may further include means, such as request module 120 and processor 550 or the like, for transmitting a request for transaction data to at least one of the two payees.

As shown in block 310, an apparatus such as authorization system 110, may include means, such as request module 120, processor 550, or the like, for receiving the multiple payee coverage request from a coverage provider. The multiple payee coverage request may be received when a coverage provider, for example, logs into the authorization system 110, such as via a service provider portal or other web-based user interface configured to provide the coverage provider with access to the authorization system for transmitting the multiple payee coverage requests. The coverage provider may enter a multiple payee coverage request by entering information via the user interface. For example, one particular claim may result in the coverage provider entering a multiple payee coverage request regarding a coverage payment to cover the loss of possessions stolen during a break-in at the residence of roommates Dan Star and Eli Harrington.

As shown in block 320 of FIG. 4, the authorization system 110, may include means, such as request module 120, processor 550, or the like, for verifying a validity of the multiple payee coverage request received from a coverage provider. Verifying the validity of the multiple payee coverage request may be achieved in part by, for example, accessing coverage provider data, which may be stored in coverage provider database 140; payee data, which may be stored in payee database 160; and/or other sources of data, e.g., an intermediary (via application 170), and/or the like. Data in the multiple payee coverage request may be compared to the accessed data to determine whether a valid coverage request has been made and/or whether a coverage payment may be made under the request. For example, request module 120 may access to coverage provider database 140 to verify that the coverage plan referenced in the multiple payee coverage request in the break-in example above includes Dan Star and Eli Harrington as the coverage plan holders.

As shown in block 330 of FIG. 4, the authorization system 110, may include means, such as request module 120, processor 550, or the like for transmitting a request for transaction data to at least one of the two payees. For example, request module 120 may transmit a message, electronic form, web link, etc. to each payee (e.g., Dan and Eli) requesting transaction data for the multiple payee coverage request.

As shown in block 340 of FIG. 4, authorization system 110, may include means, such as request module 120, processor 550, coverage provider database 140, merge database 150, payee database 160, or the like, for determining two payees based on a multiple payee coverage request. For example, the authorization system 110, via request module 120, may access coverage provider database 140, merge database 150, and/or payee database 160 to determine that the payees who may authorize the distribution of the coverage payment in the above example are Dan Star and Eli Harrington.

As shown in block 350 of FIG. 4, the authorization system 110, may include means, such as request module 120, processor 550, payee database 160, or the like, for receiving transaction data from at least one of the two payees. The transaction data may then be associated with the multiple payee coverage request. As noted above, transaction data may be defined by coverage data, account data, identity data, and/or the like and may be provided by one or more of the payees, e.g., through another web-based user interface configured to receive such information (e.g., over a secure connection). For example, authorization system 110 may transmit an email to Dan's email address (which may be stored in payee database 160 and/or memory 515) requesting transaction data for the multiple payee coverage request awaiting his authorization. The email may include, for example, a link to a website that has a user interface via which Dan may provide the requested information. The request module 120 may receive transaction data from Dan (e.g., via the user interface) that includes account holder name “Dan Star,” account number “777,” and routing number “999999999” for Dan's personal checking account. The request module may also receive transaction data from Eli (e.g., via a different user interface accessed by Eli) that designates a prepaid card as Eli's preferred distribution vehicle.

### Causing Coverage Payment Distribution

FIG. 5 shows an example method that may be executed by one or more machines (some examples of which are discussed in connection with FIGS. 2 and/or 6) to cause the coverage payment to be distributed in accordance with some embodiments discussed herein. In some embodiments, authorization system 110 may include means, such as distribution module 125 and processor 550 or the like, for determining a distribution vehicle for each payee based, at least in part, on the transaction data received as shown in block 410. As noted above, the distribution vehicle may include an automated clearing house disbursement, direct deposit, prepaid card, electronic funds transfer, check, and/or the like. For example, distribution module 125 may access merge database 150 to determine that Dan Star opted (e.g., when entering his transaction data) to receive his portion of the coverage payment via distribution vehicle “direct deposit,” while Eli Harrington opted to receive his portion via a prepaid card.

As shown in block 420, an apparatus such as authorization system 110 may include means, such as distribution module 125 and processor 550 or the like for receiving an authorization from each payee to distribute the coverage payment. The authorization may include an electronic identifier received from each payee that authorizes the distribution of the coverage payment, as described above. The electronic identifier may include, for example, an electronic signature, personal identification number, biometric identifier, and/or the like, as described above. Distribution module 125 may verify that each payee designated on the multiple payee coverage request has authorized the payment prior to distributing the coverage payment. For example, distribution module 125 may be configured to access the multiple payee coverage request (stored in the merge database 150) to retrieve electronic signatures from Dan and Eli that authorize the distribution of the coverage payment to Dan and Eli, respectively, and to verify that both payees, Dan and Eli, authorized the distribution of the coverage payment. As noted above, the electronic identifiers may, for example, have been transmitted to the authorization system by Dan and Eli via the transaction data in some cases. In other cases, the electronic identifiers may be received by the system independently of the transaction data, such as when the system sends a separate request to the payees for an electronic identifier.

As shown in block 430, in some embodiments, authorization system 110, may include means, such as distribution module 125 and processor 550 or the like, for receiving funds from a first account (e.g., an account associated with a coverage provider). For example, distribution module 125 may access a coverage provider's reserve account to receive funds to cover the loss of property due to the burglary at Dan and Eli's residence in accordance with the coverage plan in the example above.

In some example embodiments, authorization system 110, may further include means, such as distribution module 125 and processor 550 or the like, for distributing the one or more funds according to the distribution vehicle determined by transferring the one or more funds to at least one second account (e.g., an account associated with at least one of the two payees). Furthermore, authorization system 110 may include means, such as distribution module 125 and processor 550 or the like, for providing at least one check to at least one of the two payees. For example, distribution module 125 may transfer the coverage payment received from the coverage provider's reserve account to Dan's personal checking account and may transfer Eli's portion of the coverage payment to a prepaid card, according to their indicated preferences, as described above.

In some embodiments, authorization system 110, may include means, such as distribution module 125, processor 550, application 170, and/or the like, for transferring funds via an intermediary (e.g., through application 170). For example, distribution module 125 may receive funds from the coverage provider's reserve account and may access an intermediary to transfer funds to a lender to whom at least a portion of the coverage payment is due, as described in greater detail above.

### Example Scenarios—Multiple Party, Mortgage, Total Vehicle Loss

Referring now to FIGS. 7-9, example processes are shown depicting the events and activities that may be undertaken in each of three multiple payee coverage request scenarios according to embodiments of the invention. In FIG. 7, a multiple-party scenario is depicted in which a coverage provider 190 submits a multiple party coverage request (MPCR) 700 to an authorization system 110, such as via access to a service provider portal as described above. Upon processing the multiple party coverage request, determining the payees, and/or receiving transaction data, etc., the authorization system 110 (e.g., via a notification module as described above) may message the payees at 710 to request authorization for distributing the coverage payment, as described above. As noted above, the messaging may occur as part of the request for transaction data or independently from the request for transaction data. The payees may then authorize the payment and provide payment details (e.g., account numbers, form of payment, amount, etc., as described above) at 720. If all of the payees who are required to do so authorize the payment at decision block 730, funds for the coverage payment may be distributed from the coverage provider's reserve account to the payees' account at 740, as described above. If fewer than all of the required authorizations are received, one or more of the payees may be re-messaged in an attempt to obtain the appropriate authorizations.

In a more complicated scenario shown in FIG. 8, in which some of the payees are homeowners and the house that is the subject of the coverage plan is under a mortgage contract, after the coverage provider 190 submits the multiple party coverage request (MPCR) 700 to an authorization system 110 and the authorization system processes the MPCR to determine the payees, and/or receive transaction data, etc., the authorization system 110 (e.g., via a notification module as described above) may message the homeowner payees at 750. The homeowner payee(s) may then authorize the payment and provide payment method details, as descried above. Once all homeowner payees have authorized the payment at 770, a message may be sent to the mortgagee at 780 requesting authorization to pay the coverage payment to the homeowner payee. If the mortgagee authorizes the payment at 785 (e.g., in a non-monitored account situation), the payment of the coverage payment may be made to the homeowner payee(s) at 790. If, however, the account is monitored, the mortgagee may not authorize the payment to the payee(s), and the coverage payment may be placed in the homeowner(s) escrow account. As noted above, the messaging may occur as part of the request for transaction data or independently from the request for transaction data.

In FIG. 9, another scenario is shown in which the claim against the coverage plan is a result of the total loss of a vehicle, where money is still owed to a lender on the vehicle. In this case, After the multiple payee coverage request (MPCR) 700 submitted by the coverage provider 190 is received at the authorization system 110 and processed, as described above, some or all of the coverage payment may be paid to the lender (e.g., the issuer of the vehicle loan) to satisfy the loan amount. As described above, the payment to the lender may be made via an intermediary at 800, such as in the case where the payment is made via an electronic funds transfer to an account held by the lender that is not accessible other than through the intermediary. Once the loan amount has been satisfied, any portion of the coverage payment that remains may be transferred to the payee(s) at 810, as described above.

### Example System Architecture

Disclosed are various systems, methods, apparatuses, and computer program products for utilizing a multiple payee coverage request as a trigger for obtaining authorizations for, or otherwise generating, a coverage payment distribution using an authorization system, such as authorization system 110. Regarding authorization system 110, FIG. 6 depicts an example schematic block diagram of circuitry, some or all of which may be included in an example embodiment. The system may include one or more devices and sub-systems that are configured to implement some of the example embodiments discussed herein. For example, the system may include authorization system 110, which may include, for example, memory 515, one or more processors 550, communication interface 555, and input/output module 580. Memory 515 may include and/or otherwise be accessible to request module 120, distribution module 125, and/or notification module 130. As referred to herein, the term “module” includes hardware, software and/or firmware configured to perform one or more particular functions. In this regard, the means of the device's circuitry as described herein may be embodied as, for example, circuitry, hardware elements (e.g., a suitably programmed processor, combinational logic circuit, and/or the like), a computer program product comprising computer-readable program instructions stored on a non-transitory computer-readable medium (e.g., memory 515) that is executable by a suitably configured processing device (e.g., processor 550), or some combination thereof.

The authorization system 110 may comprise one or more distinct computing systems/devices and may span distributed locations. In other example embodiments, a pre-processing module or other module that requires heavy computational load may be configured to perform that computational load and thus may be on a remote device or server. Furthermore, each block shown may represent one or more such blocks as appropriate to a specific example embodiment. In some cases one or more of the blocks may be combined with other blocks.

Processor 550 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit (ASIC) or field programmable gate array (FPGA), or some combination thereof. Accordingly, although illustrated in FIG. 5 as a single processor, in some embodiments, processor 550 comprises a plurality of processors. The plurality of processors may be embodied on a single computing device or may be distributed across a plurality of computing devices collectively. The plurality of processors may be in operative communication with each other and may collectively be configured to perform one or more functionalities of an authorization system as described herein. In an example embodiment, processor 550 may be configured to execute instructions stored in memory 515 or otherwise accessible to processor 550. These instructions, when executed by processor 550, may cause authorization system 110 to perform one or more of the functionalities as described herein.

Whether configured by hardware, firmware/software methods, or by a combination thereof, processor 550 may comprise an entity capable of performing operations according to embodiments of the present invention while configured accordingly. Thus, for example, when processor 550 is embodied as an ASIC, FPGA, or the like, processor 550 may comprise specifically configured hardware for conducting one or more operations described herein. Alternatively, as another example, when processor 550 is embodied as an executor of instructions, such as may be stored in memory 515, the instructions may specifically configure processor 550 to perform one or more algorithms and operations described herein.

Memory 515 may comprise, for example, volatile memory, non-volatile memory, or some combination thereof. Although illustrated in FIG. 6 as a single memory, memory 515 may comprise a plurality of memory components. The plurality of memory components may be embodied on a single computing device or distributed across a plurality of computing devices. In various embodiments, memory 515 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 515 may be configured to store information, data (including coverage plan data, transaction data, account data, merge data, distribution data, and/or notification data), applications, instructions, or the like for enabling authorization system 110 to carry out various functions in accordance with example embodiments of the present invention.

In at least some embodiments, memory 515 may be configured to buffer input data for processing by processor 550. Alternatively or additionally, in at least some embodiments, memory 515 may be configured to store program instructions for execution by processor 550. Memory 515 may store information in the form of static and/or dynamic information. This stored information may be stored and/or used by user device 565 or coverage provider device 570 during the course of performing its functionalities.

As may be understood from FIG. 6 in this embodiment, the system includes one or more user devices 565 and/or coverage provider devices 570 that are connected, via a network 560 (e.g., a LAN or the Internet), to communicate with the authorization system. The user device 565 and the coverage provider device 570 are merely shown to illustrate the potential for multiplicity in relation to the number of devices that may interface with the authorization system. Thus, some embodiments may employ only one of user device 565 and coverage provider device 570, while other embodiments may employ two or more such devices.

In an example embodiment, either or both of user device 565 and coverage provider device 570 may be a personal computer (PC) or a laptop computer associated with a particular individual or organization. For example, one or more computers may be associated with payees and another one or more computers may be associated with a coverage provider or other entity. However, either or both of user device 565 and coverage provider device 570 may be a personal digital assistant (PDA), mobile telephone (or smart phone), or a client terminal associated with a coverage provider, payee, or other entity. As such, in some cases, user device 565 or coverage provider device 570 may represent a terminal for allowing a user to interface with the authorization system 110.

Communication interface 555 may be embodied as any device or means embodied in circuitry, hardware, a computer program product comprising computer readable program instructions stored on a computer readable medium (e.g., memory 515) and executed by a processing device (e.g., processor 550), or a combination thereof that may be configured to receive and/or transmit data from/to another device, such as, for example, user device 565, coverage provider device 570, and/or the like. In some embodiments, communication interface 555 (like other components discussed herein) can be at least partially embodied as or otherwise controlled by processor 550. In this regard, communication interface 555 may be in communication with processor 550, such as via a bus. Communication interface 555 may include, for example, an antenna, a transmitter, a receiver, a transceiver, network interface card and/or supporting hardware and/or firmware/software for enabling communications with another computing device. Communication interface 555 may be configured to receive and/or transmit any data that may be stored by memory 515 using any protocol that may be used for communications between computing devices. Communication interface 555 may, alternatively or additionally, be in communication with the memory 515, input/output module 580 and/or any other component of authorization system 110, such as via a bus.

Input/output module 580 may be in communication with processor 550 to receive an indication of a user input and/or to provide an audible, visual, mechanical, or other output to a user. As such, input/output module 580 may include support, for example, for a keyboard, a mouse, a joystick, a display, a touch screen display, a microphone, a speaker, a RFID reader, credit card reader, barcode reader, biometric scanner, and/or other input/output mechanisms as represented by input/output module 580. Input/output module 580 may be in communication with the memory 515, communication interface 555, and/or any other component(s), such as via a bus. Although more than one input/output module and/or other components can be included in authorization system 110, only one is shown in FIG. 6 to avoid overcomplicating the drawing and associated description.

FIG. 6 also shows an example circuitry that may be included in authorization system 110, which may be configured to perform the functionality discussed herein. As illustrated in FIG. 6 and in accordance with some example embodiments, authorization system 110 may include various means, such as request module 120, distribution module 125, and/or notification module 130. Although three modules are illustrated and described in the example embodiments, it is understood that additional or fewer modules may be used, according to the particular configuration of the authorization system and/or user preferences.

Each of the request module 120, distribution module 125, and notification module 130 may be included and configured to perform the functionality discussed herein related to receiving a multiple payee coverage request to generate and distribute a coverage payment in accordance with a coverage plan. The request module 120 may receive (e.g., from a coverage provider via coverage provider device 570) a multiple payee coverage request. In some embodiments, request module 120 may verify the validity of the multiple payee coverage request received and may transmit a request for transaction data to at least one of the two payees (e.g., via a request transmitted to the payees' associated user devices 565). In some embodiments some or all of the functionality of receiving and/or verifying the multiple payee coverage request and/or transmitting a request for transaction data may be generated by processor 550. For example, non-transitory computer readable media can be configured to store firmware, one or more application programs, and/or other software, which include instructions and other computer-readable program code portions that can be executed to control each processor (e.g., processor 550 and/or request module 120) of the components of authorization system 110 to implement various operations, including the examples shown above. As such, a series of computer-readable program code portions are embodied in one or more computer program products and can be used, with a computing device, server, and/or other programmable apparatus, to produce machine-implemented processes.

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Embodiments of the present invention have been described above with reference to block diagrams and flowchart illustrations of methods, apparatuses, systems and computer program products. It will be understood that each block of the circuit diagrams and process flowcharts, and combinations of blocks in the circuit diagrams and process flowcharts, respectively, can be implemented by various means including computer program instructions. These computer program instructions may be loaded onto a general purpose computer, special purpose computer, or other programmable data processing apparatus to produce a machine, such that the computer program product includes the instructions, which execute on the computer or other programmable data processing apparatus create a means for implementing the functions specified in the flowchart block or blocks.

These computer program instructions may also be stored in a computer-readable storage device that can direct a computer or other programmable data processing apparatus to function in a particular manner, such that the instructions stored in the computer-readable storage device produce an article of manufacture including computer-readable instructions for implementing the function discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein.

Accordingly, blocks of the block diagrams and flowchart illustrations support combinations of means for performing the specified functions, combinations of steps for performing the specified functions and program instruction means for performing the specified functions. With regard to such flowchart illustrations, while various embodiments are described as sequential steps for illustrative purposes, the inventive concepts described herein are not necessarily limited to the sequences illustrated. Indeed, various steps may be performed before or after the other as may be apparent to one of ordinary skill in the art in view of the disclosure. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving, via a processor, a multiple payee coverage request to generate a coverage payment in accordance with a coverage plan;
determining, via the processor, two or more payees based on the multiple payee coverage request;
receiving transaction data from at least one of the two or more payees and associating, via the processor, the transaction data with the multiple payee coverage request;
determining, via the processor, a distribution vehicle for each payee based, at least in part, on the transaction data received; and
causing, via the processor, the coverage payment to be distributed according to the respective distribution vehicles determined.

2. The method of claim 1, wherein the at least one of the two or more payees is a lender, the method further comprising:
generating coverage plan data describing an event triggering the multiple payee coverage request; and
transmitting the coverage plan data, via the processor, to the lender.

3. The method of claim 1, wherein the two or more payees comprise at least one of a policyholder, a lender, or a vendor of goods or services.

4. The method of claim 1, wherein the coverage payment is divided into a first coverage payment and one or more subsequent coverage payments.

5. The method of claim 1, wherein receiving the multiple payee coverage request to generate a coverage payment in accordance with a coverage plan comprises:
receiving, from a coverage provider, the multiple payee coverage request;
verifying a validity of the multiple payee coverage request; and
transmitting a request for transaction data to at least one of the two or more payees.

6. The method of claim 1, wherein causing the coverage payment to be distributed comprises:
receiving, from each payee, an authorization, wherein the authorization comprises an electronic identifier, to distribute the coverage payment; and
upon receiving the authorization from each payee, receiving, from a first account associated with a coverage provider, one or more funds and distributing the one or more funds according to the distribution vehicle determined by transferring the one or more funds to at least one second account associated with at least one of the two or more payees or providing at least one check to the at least one of the two or more payees.

7. The method of claim 6, wherein the one or more funds are transferred via an intermediary, the intermediary being at least one of a settlement funds transfer application, electronic billing application, or automated clearing house application.

8. The method of claim 1 further comprising:
generating a notification describing a status of the multiple payee coverage request; and
transmitting the notification to at least one of the two or more payees, wherein the notification comprises at least one of a text message, a link, an email message, an icon, or a button.

9. An apparatus comprising at least one processor and at least one memory including computer program code, the at least one memory and the computer program code configured to, with the processor, cause the apparatus to at least:
receive a multiple payee coverage request to generate a coverage payment in accordance with a coverage plan;
determine two or more payees based on the multiple payee coverage request;
receive transaction data from at least one of the two or more payees and associate the transaction data with the multiple payee coverage request;
determine a distribution vehicle for each payee based, at least in part, on the transaction data received; and
cause the coverage payment to be distributed according to the respective distribution vehicles determined.

10. The apparatus of claim 9, wherein the at least one of the two payees is a lender, wherein the at least one memory and the computer program code are further configured to, with the processor, cause the apparatus to:
generate coverage plan data describing an event triggering the multiple payee coverage request; and
transmit the coverage plan data, via the processor, to the lender.

11. The apparatus of claim 9, wherein the at least one memory and the computer program code are further configured to, with the processor, cause the apparatus to:
receive the multiple payee coverage request to generate a coverage payment in accordance with a coverage plan by receiving, from a coverage provider, the multiple payee coverage request;
verify a validity of the multiple payee coverage request; and
transmit a request for transaction data to at least one of the two or more payees.

12. The apparatus of claim 9, wherein the at least one memory and the computer program code are further configured to, with the processor, cause the apparatus to cause the coverage payment to be distributed by:
receiving, from each payee, an authorization, wherein the authorization comprises an electronic identifier, to distribute the coverage payment; and
upon receiving the authorization from each payee, receiving, from a first account associated with a coverage provider, one or more funds and distributing the one or more funds according to the distribution vehicle determined by transferring the one or more funds to at least one second account associated with at least one of the two or more payees or providing at least one check to the at least one of the two or more payees.

13. The apparatus of claim 12, wherein the at least one memory and the computer program code are further configured to, with the processor, cause the apparatus to transfer the one or more funds via an intermediary, the intermediary being at least one of a settlement funds transfer application, electronic billing application, or automated clearing house application.

14. The apparatus of claim 9, wherein the at least one memory and the computer program code are further configured to, with the processor, cause the apparatus to generate a notification describing a status of the multiple payee coverage request; and transmit the notification to at least one of the two or more payees, wherein the notification comprises at least one of a text message, a link, an email message, an icon, or a button.

15. A computer program product comprising at least one non-transitory computer-readable storage medium having computer-executable program code portions stored therein, the computer-executable program code portions comprising program code instructions for:
receiving a multiple payee coverage request to generate a coverage payment in accordance with a coverage plan;
determining two or more payees based on the multiple payee coverage request;
receiving transaction data from at least one of the two or more payees and associating the transaction data with the multiple payee coverage request;
determining a distribution vehicle for each payee based, at least in part, on the transaction data received; and
causing the coverage payment to be distributed according to the respective distribution vehicles determined.

16. The computer program product of claim 15, wherein the at least one of the two or more payees is a lender, the computer program product further comprising program code instructions for generating coverage plan data describing an event triggering the multiple payee coverage request; and transmitting the coverage plan data, via the processor, to the lender.

17. The computer program product of claim 15, the computer program product further comprising program code instructions for receiving, from a coverage provider, the multiple payee coverage request; verifying a validity of the multiple payee coverage request; and transmitting a request for transaction data to at least one of the two or more payees.

18. The computer program product of claim 15, the computer program product further comprising program code instructions for
receiving, from each payee, an authorization, wherein the authorization comprises an electronic identifier, to distribute the coverage payment; and
upon receiving the authorization from each payee, receiving, from a first account associated with a coverage provider, one or more funds and distributing the one or more funds according to the distribution vehicle determined by transferring the one or more funds to at least one second account associated with at least one of the two or more payees or providing at least one check to the at least one of the two or more payees.

19. The computer program product of claim 18, the computer program product further comprising program code instructions for transferring the one or more funds via an intermediary, the intermediary being at least one of a settlement funds transfer application, electronic billing application, or automated clearing house application.

20. The computer program product of claim 15, the computer program product further comprising program code instructions for generating a notification describing a status of the multiple payee coverage request; and transmitting the notification to at least one of the two or more payees, wherein the notification comprises at least one of a text message, a link, an email message, an icon, or a button.
